(19) United States
(12) Patent Application Publication
(10) Pub. No.: US 2009/0325719 A1
(43) Pub. Date: Dec. 31, 2009

(54) Dynamic Damper

(75) Inventor: Takafumi Murakami, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd

(21) Appl. No.: 11/922,209

(22) PCT Filed: Mar. 24, 2006
(86) PCT No.: PCT/JP2006/306037

§ 371 Date: Dec. 14, 2007

(30) Foreign Application Priority Data
Jun. 15, 2005 (JP) 2005-175410

(51) Int. Cl. F16F 15/126

(52) U.S. Cl. 464/180

(57) ABSTRACT

A dynamic damper, wherein flat surfaces approximately orthogonal to the axis of a drive shaft and facing each other are formed on the side walls of mass parts adjacent to each other. Where distances along the axial direction of the drive shaft between center points C bisecting the lateral dimensions D of the connection support parts and the gravity centers G of weights are A and the lateral dimensions of the mass parts having the weights and positioned parallel with the axis of the drive shaft are B, the distances A and the lateral dimensions B are set to fulfill the requirement of the relational expression A≦(B/3).

### TECHNICAL FIELD

The present invention relates to a dynamic damper mounted on a rotational shaft such as a drive shaft of an automobile or the like, for dampening hazardous vibrations developed on the rotational shaft.

### BACKGROUND ART

Heretofore, there is known a dynamic damper mounted on a rotational shaft such as a drive shaft or a propeller shaft of an automobile or the like, for damping hazardous vibrations which should not be caused, such as flexural vibrations, torsional vibrations, etc. that are developed due to an unbalanced rotational behavior caused when the rotational shaft rotates.

The dynamic damper has a function to absorb the vibrational energy of the rotational shaft by converting the vibrational energy into vibrational energy of the dynamic damper by way of resonance, with the natural frequency of the dynamic damper being equal to the dominant frequency of excited hazardous vibrations of the rotational shaft.

One dynamic damper of the above type, which is disclosed in Japanese Laid-Open Patent Publication No. 11-101306, for example, comprises a tubular member of rubber having a boss with a rotational shaft press-fitted therein and a joint support integrally formed with an outer surface of the boss, a ring-shaped mass member disposed radially outwardly of the boss and elastically joined to and supported on the boss by the joint support, and a ring-shaped securing fitting for securing the boss to the rotational shaft. The disclosed dynamic damper allows the rotational shaft to be fitted and mounted easily therein and makes the securing member resistant to corrosion.

Japanese Laid-Open Patent Publication No. 2003-254387 discloses a dynamic damper having two different first and second vibroisolating members which are mounted together on a drive shaft. The dynamic damper can dampen vibrations at two different natural frequencies of the drive shaft to be controlled, by independently adjusting the properties and structures of rubber elastomers of the first and second vibroisolating members.

When the dynamic dampers disclosed in Japanese Laid-Open Patent Publication No. 11-101306 and Japanese Laid-Open Patent Publication No. 2003-254387 are actually manufactured, since they are complexly shaped, the manufacturing operation and the manufacturing process are complex, and they are costly to manufacture.

Specifically, if the dynamic dampers are manufactured by pouring a rubber material into a mold, then since the dynamic dampers disclosed in Japanese Laid-Open Patent Publication No. 11-101306 and Japanese Laid-Open Patent Publication No. 2003-254387 are complex in shape and structure, the mold has a complex cavity structure and is of a high cost, which is reflected in the cost of the products.

As vehicles are becoming more compact and more space saving in recent years, their engine compartments are also becoming smaller in volume. Accordingly, there are demands for smaller dynamic dampers. Different vehicle types have different dimensions and shapes as to engine compartment spaces and engine components. As the layout of mechanisms and devices mounted on automobile bodies, i.e., the vehicle layout, has a low level of freedom, it is necessary that the dimensions and shapes of dynamic dampers be individually set out of interference with surrounding mechanisms and devices. Consequently, dynamic dampers and molds for dynamic dampers need to be prepared in a vast range of types, resulting in high equipment investments.

### DISCLOSURE OF THE INVENTION

It is a general object of the present invention to provide a dynamic damper which is simple and small in shape and structure, so that a cavity structure of a mold for forming the dynamic damper is simplified to reduce the cost incurred to manufacture the dynamic damper.

According to the present invention, wall surfaces between a plurality of adjacent mass members are provided by flat surfaces that confront each other. Therefore, they provide a simple shape for allowing a mold to be easily removed when the mold is opened, and hence the dynamic damper can easily be manufactured.

According to the present invention, furthermore, by setting a spaced distance A and the width B of the mass members to satisfy the positional relationship A≦(B/3) between joint supports and the mass members, the lateral moment of the mass members along the axial direction of a rotational shaft can be suppressed, and the mass members can be set to a desired resonant frequency. Consequently, the vibrations of the rotational shaft are reliably attenuated by tensile/compressive deformation or shearing deformation (resonance).

According to the present invention, when the rotational shaft rotates, the joint supports may be subjected to tensile/compressive deformation in a diametrical direction of the rotational shaft, or may be subjected to shearing deformation in a circumferential direction of the rotational shaft. The joint supports may be simultaneously subjected to tensile/compressive deformation and shearing deformation.

The tensile/compressive deformation refers to the deformation of the joint supports as they are extended or compressed in the diametrical direction of the rotational shaft. The shearing deformation refers to the deformation of the joint supports as they are pulled in the circumferential direction of the rotational shaft, i.e., a direction opposite to the direction in which the rotational shaft rotates.

### BRIEF DESCRIPTION OF THE DRAWINGS

FIG. 1 is a vertical cross-sectional view, partly omitted from illustration, of a drive force transmitting mechanism incorporating a dynamic damper according to an embodiment of the present invention;

FIG. 2 is a schematic perspective view of the dynamic damper shown in FIG. 1;

FIG. 3 is an enlarged vertical cross-sectional view of the dynamic damper incorporated in the drive force transmitting mechanism shown in FIG. 1 and the vicinity thereof;

FIG. 4 is an enlarged partial view showing the positional relationship between mass members and joint supports of the dynamic damper shown in FIG. 1;

FIG. 5 is a fragmentary vertical cross-sectional view showing the manner in which the dynamic damper is formed using a mold;

FIG. 6 is an enlarged vertical cross-sectional view of a dynamic damper having two mass members according to another embodiment of the present invention;

FIG. 7 is an enlarged vertical cross-sectional view of a dynamic damper having two mass members according to still another embodiment of the present invention;

FIG. 8 is a graph showing the relationship between the specific gravity and rigidity of a weight;

FIG. 9 is a graph showing the relationship between the specific gravity and the amount of flexure of the weight;

FIG. 10 is an enlarged vertical cross-sectional view of a dynamic damper having three mass members according to yet another embodiment of the present invention;

FIG. 11 is an enlarged vertical cross-sectional view of a dynamic damper having three mass members according to yet still another embodiment of the present invention;

FIG. 12 is an enlarged vertical cross-sectional view of a dynamic damper having three mass members according to a further embodiment of the present invention;

FIG. 13 is an enlarged vertical cross-sectional view of a dynamic damper having three mass members according to a still further embodiment of the present invention;

FIG. 14 is an enlarged vertical cross-sectional view of a dynamic damper having three mass members according to a yet further embodiment of the present invention; and

FIG. 15 is an enlarged vertical cross-sectional view of a dynamic damper having three mass members according to a yet still further embodiment of the present invention.

### BEST MODE FOR CARRYING OUT THE INVENTION

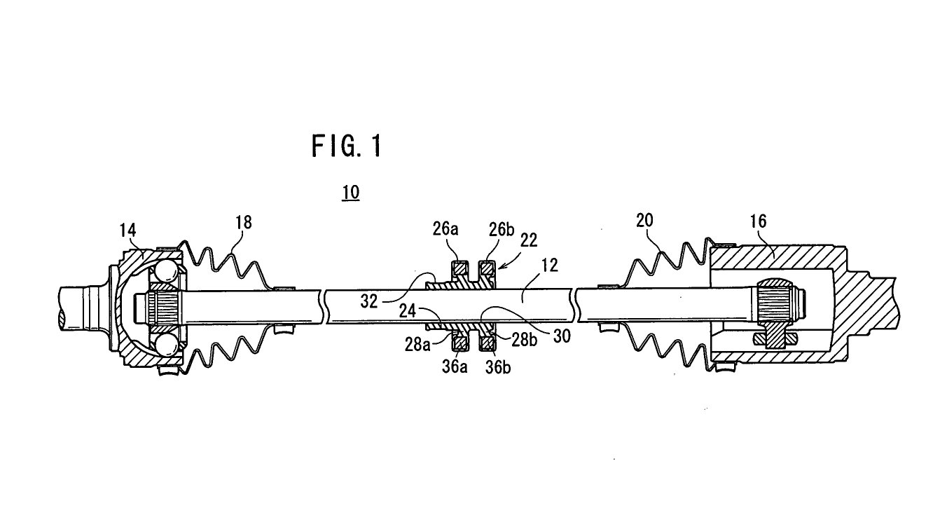

FIG. 1 is a vertical cross-sectional view, partly omitted from illustration, of a drive force transmitting mechanism in which a dynamic damper according to an embodiment of the present invention is mounted on a drive shaft as a rotational shaft.

The drive force transmitting mechanism 10 comprises a drive shaft 12, and a Barfield constant velocity universal joint 14 and a tripod constant velocity universal joint 16 which are joined to the respective ends of the drive shaft 12. Joint boots 18, 20 made of rubber or resin are mounted respectively on the Barfield constant velocity universal joint 14 and the tripod constant velocity universal joint 16. A dynamic damper 22 is mounted substantially centrally on the drive shaft 12 by a band, not shown.

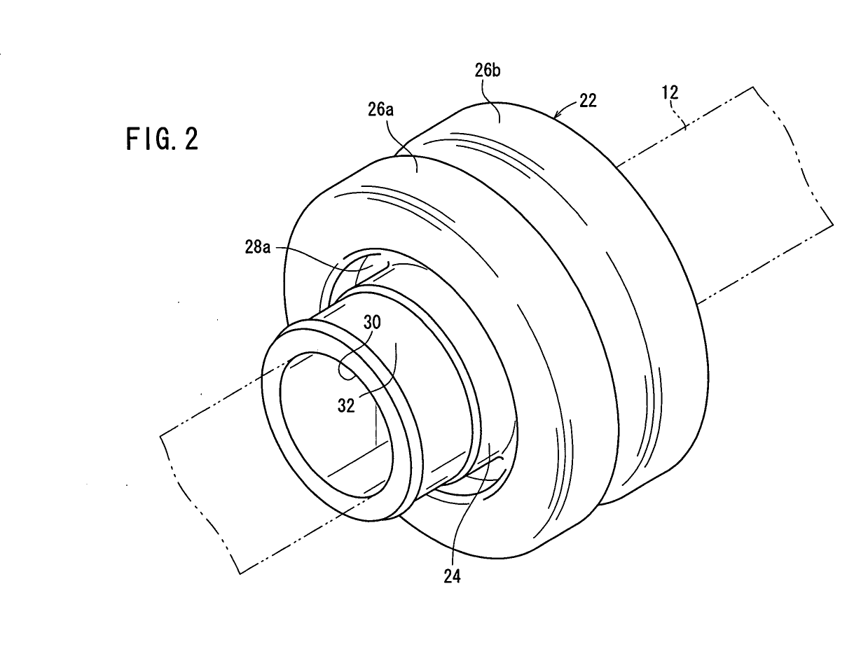

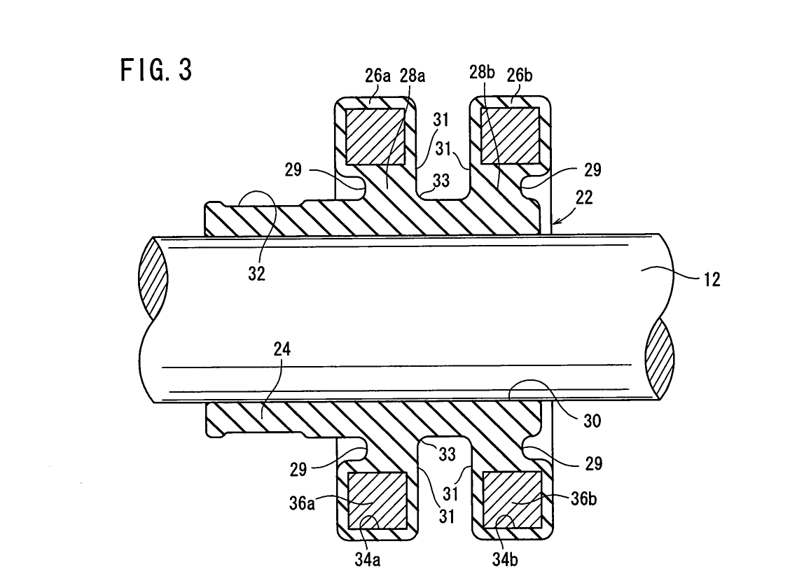

As shown in FIGS. 2 and 3, the dynamic damper 22 comprises a cylindrical main body 24 surrounding an outer circumferential surface of the drive shaft 12, two mass members 26a, 26b projecting diametrically outwardly of the drive shaft 12, and annular joint supports 28a, 28b joining the main body 24 and the mass members 26a, 26b, respectively. The main body 24, the joint supports 28a, 28b, and the mass members 26a, 26b are integrally molded of a rubber material as a single member.

The main body 24 has a through hole 30 defined therein, and the drive shaft 12 extends through the through hole 30. The non-illustrated band is wound in an annular recess 32 defined in a circumferential side wall of the main body 24. When the band is tightened, the dynamic damper 22 is positioned and secured in position on the drive shaft 12.

The joint supports 28a, 28b project from the main body 24 diametrically outwardly of the drive shaft 12, and are flexible to support the mass members 26a, 26b elastically.

Specifically, as shown in FIG. 3, the joint supports 28a, 28b are disposed between the mass members 26a, 26b and the main body 24 which are positioned on respective outer and inner circumferential sides with respect to the drive shaft 12. The joint supports 28a, 28b have respective curved surfaces 29 in one side surfaces thereof substantially perpendicular to the axis of the drive shaft 12, the curved surfaces 29 being greatly constricted in vertical cross section. The other side surfaces of the joint supports 28a, 28b comprise flat surfaces which are linear in vertical cross section substantially perpendicular to the axis of the drive shaft 12. The flat surfaces 31 are contiguous to the main body 24 through beveled corners 33 having a predetermined radius of curvature.

As shown in FIG. 3, the flat surface 31 of the one joint support 28a and the flat surface 31 of the other joint support 28b are disposed in confronting relation substantially parallel to each other on the insides of the mass members 26a, 26b that are disposed along the axial direction of the drive shaft 12. The curved surface 29 of the one joint support 28a and the curved surface 29 of the other joint support 28a are disposed substantially symmetrically and spaced a given distance from each other on the outsides of the mass members 26a, 26b that are disposed along the axial direction of the drive shaft 12.

Since the wall surfaces between the mass members 26a, 26b are provided by the flat surfaces 31, 31 that face each other, the dynamic damper can easily be removed from a mold when the mold is opened (described later), and hence can simply be manufactured.

The annular mass members 26a, 26b which extend around the circumferential side wall of the drive shaft 12 have respective annular spaces 34a, 34b of rectangular cross section defined therein. Weights 36a, 36b are housed respectively in the spaces 34a, 34b. When the drive shaft 12 is vibrated, the weights 36a, 36b are displaced in unison with the mass members 26a, 26b.

The weights 36a, 36b each comprise a sintered body produced when a powder of tungsten alloy mixed with a metal binder is sintered. However, the weights 36a, 36b may each comprise a molded body produced by a metal injection molding (MIM) process or a powder injection molding (PIM) process, rather than a sintered body. The weights 36a, 36b thus constructed have a specific gravity which generally exceeds 14, e.g., a high specific gravity of 17 or more, and hence have a very large weight.

Preferred examples of tungsten alloy are W-1.8Ni-1.2Cu (a specific gravity of 18.5, the numerals prior to the elements represent weight %, the same being true with the examples below), W-3.0Ni-2.0Cu (a specific gravity of 17.8), W-5.0Ni-2.0Fe ((a specific gravity of 17.4), and W-3.5Ni-1.5Fe ((a specific gravity of 17.6), etc. The specific gravity of the weights 36a, 36b made of tungsten alloy is more than twice weights made of an iron material. If the weights 36a, 36b have the same mass as weights made of an iron material, then the weights 36a, 36b have a volume which is about ⅓ to ½ of those weights.

In other words, if the weights 36a, 36b are made of tungsten alloy, then their size is much smaller than the conventional weights of an iron material.

The positional relationship between the mass member 26a (26b) and the joint support 28a (28b) will be described below.

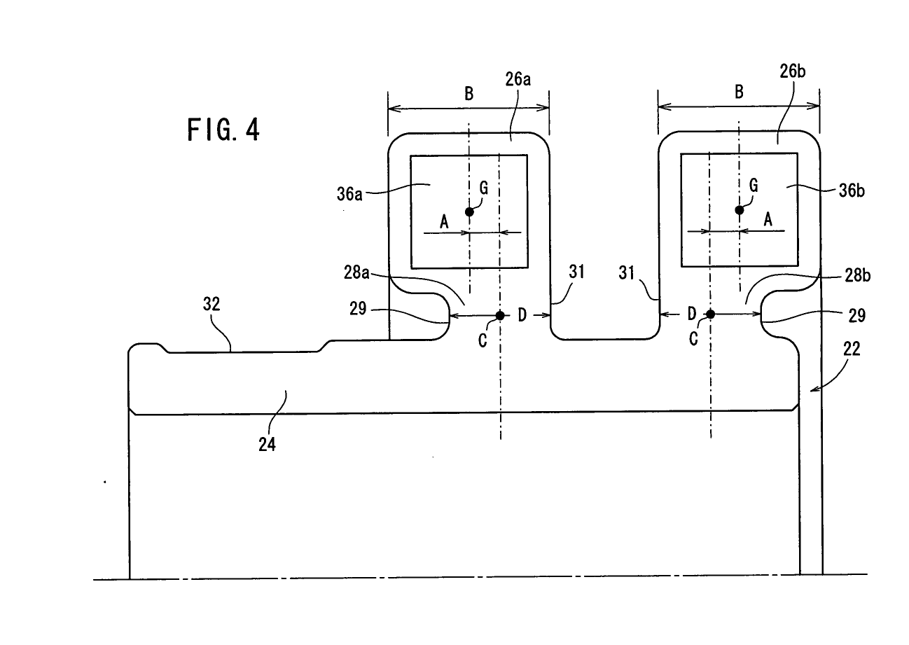

As shown in FIG. 4, the width of the joint support 28a (28b) parallel to the axis of the drive shaft 12 is represented by D, the spaced distance along the axis of the drive shaft 12 between a central point C (D/2) of the joint support 28a (28b) which bisects the width D of the joint support 28a (28b) and the center G of gravity of the weight 36a (36b) by A, and the width of the mass member 26a (26b) including the weight 36a (36b) parallel to the axis of the drive shaft 12 by B. It is preferable that the spaced distance A be equal to or smaller than ⅓ of the width B (A≦B/3).

The above dimensional relationship includes the instance wherein the central point C (D/2) of the joint support 28a (28b) along the axis of the drive shaft 12 is aligned with the center G of gravity of the weight 36a (36b), so that the spaced distance A between the central point C of the joint support 28a (28b) and the center G of gravity of the weight 36a (36b) is 0.

By setting the spaced distance A and the width B of the mass member 26a (26b) to satisfy the relationship A≦B/3, a lateral moment of the mass members 26a, 26b along the axis of the drive shaft 12 can be suppressed, and the mass members 26a, 26b can be set to a desired resonant frequency. The above relationship is applicable to not only the two mass members 26a, 26b, but also to all two or more mass members.

Stated otherwise, if the relationship A≦B/3 is not satisfied, then a lateral moment of the mass member 26a (26b) increases, making it difficult to set the mass member 26a (26b) to a desired resonant frequency, and the mass member 26a (26b) may possibly have a portion brought into contact with the drive shaft 12 or the main body 24, adversely affecting them.

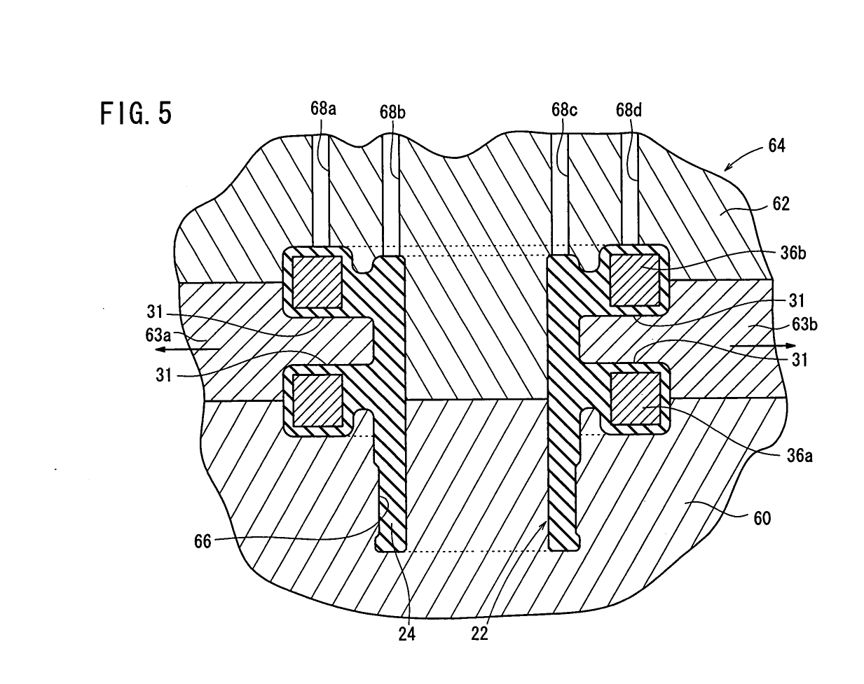

As shown in FIG. 5, the weights 36a, 36b may be placed in advance by attachments, not shown, in a cavity 66 of a mold 64 which comprises a lower mold 60, an upper mold 62, a left mold 63a, and a right mold 63b, and a rubber material may be injected into the cavity 66 through supply passages 68a through 68d defined in the upper mold 62.

Since the flat surfaces 31, 31 are provided between the two mass members 26a, 26b, the mold 64 can easily be opened by displacing the left and right molds 63a, 63b in horizontal directions (indicated by the arrows in FIG. 5) away from each other.

The dynamic damper 22 according to the present embodiment is basically constructed as described above. Operation and advantages of the dynamic damper 22 will be described below.

First, the drive shaft 12 is inserted to a given position through the through hole 30 defined in the main body 24 of the dynamic damper 22. Thereafter, the non-illustrated band is wound and tightened in the annular recess 32 of the main body 24. The dynamic damper 22 is now positioned and fixed in the predetermined position on the drive shaft 12.

According to the present embodiment, since the wall surfaces between the two mass members 26a, 26b are a pair of the flat surfaces 31, 31, they provide a simple shape for allowing the mold 64 (the left and right molds 63a, 63b) to be easily removed when the mold 64 is opened, as shown in FIG. 5, and hence the dynamic damper 22 can easily be manufactured.

In the drive force transmitting mechanism 10 mounted on a vehicle, the dynamic damper 22 is mounted on the drive shaft 12 as described above. According to the present embodiment, the weights 36a, 36b and hence the mass members 26a, 26b are very small in volume. Therefore, as the dynamic damper 22 is prevented from interfering with surrounding mechanisms and devices, those mechanisms and devices can be laid out with increased freedom in the vehicle. Stated otherwise, a wider choice of vehicle layouts is available.

Inasmuch as the dynamic damper 22 can be installed in various vehicle layouts, the range of vehicles that can be selected for the installation of the dynamic damper 22 is greatly increased. Stated otherwise, it is unnecessary to change the dimensions or the shape of the dynamic damper 22 depending on the types of vehicles. Thus, the trouble of having to design many types of dynamic dampers is eliminated, and equipment investments are lowered because there is no need for the preparation of many types of molds.

According to the present embodiment, since the weights 36a, 36b and hence the mass members 26a, 26b are reduced in size, a plurality of mass members 26a, 26b can be provided (see FIGS. 2 and 3) for efficiently absorbing vibrational energy developed in the drive shaft 12 and appropriately suppressing vibrations.

When the drive shaft 12 is vibrated for some reasons, the mass members 26a, 26b which accommodate the respective weights 36a, 36b are subjected to at least one of tensile/compressive deformation and shearing deformation.

Specifically, when the drive shaft 12 is undesirably vibrated, the vibrations are transmitted from the main body 24 through the joint supports 28a, 28b to the mass members 26a, 26b. At this time, the mass members 26a, 26b which accommodate the respective weights 36a, 36b and have their resonant frequency matching the frequency of the unwanted vibrations are extended and contracted from the joint supports 28a, 28b along the diametrical direction of the drive shaft 12, i.e., are subjected to tensile/compressive deformation.

The joint supports 28a, 28b may be deformed so as to be pulled along a circumferential direction of the drive shaft 12, i.e., a direction opposite to the direction in which the drive shaft 12 rotates, or in other words may be subjected to shearing deformation. Of course, the joint supports 28a, 28b may be simultaneously subjected to tensile/compressive deformation and shearing deformation.

Upon the tensile/compressive deformation or the shearing deformation, the mass members 26a, 26b (the weights 36a, 36b) resonate. Since the mass members 26a, 26b are essentially identical in shape to each other, they have essentially the same resonant frequency, and hence absorb the vibrational energy developed in the drive shaft 12 and appropriately suppress vibrations.

Specifically, the vibrations of the drive shaft 12 are attenuated when the mass members 26a, 26b (the weights 36a, 36b) elastically supported by the flexible joint supports 28a, 28b resonate.

By setting the spaced distance A and the width B of the mass members 26a, 26b to satisfy the positional relationship A≦(B/3) between the joint supports 28a, 28b and the mass members 26a, 26b, the lateral moment of the mass members 26a, 26b along the axial direction of the drive shaft 12 can be suppressed, and the mass members 26a, 26b can be set to a desired resonant frequency. Consequently, the vibrations of the drive shaft 12 are reliably attenuated by the tensile/compressive deformation or the shearing deformation (resonance).

According to the present embodiment, at least one of tensile/compressive deformation and shearing deformation occurs on the joint supports 28a, 28b of the dynamic damper 22. If only shearing deformation occurs, then the dimension of the dynamic damper in the longitudinal direction of the drive shaft 12 increases, and if only tensile/compressive deformation occurs, the dimension of the dynamic damper in the diametrical direction of the drive shaft 12 increases. However, the dynamic damper 22 according to the present embodiment has reduced dimensions in both the longitudinal and diametrical directions of the drive shaft 12. Accordingly, the dynamic damper 22 can easily be assembled on the drive shaft 12.

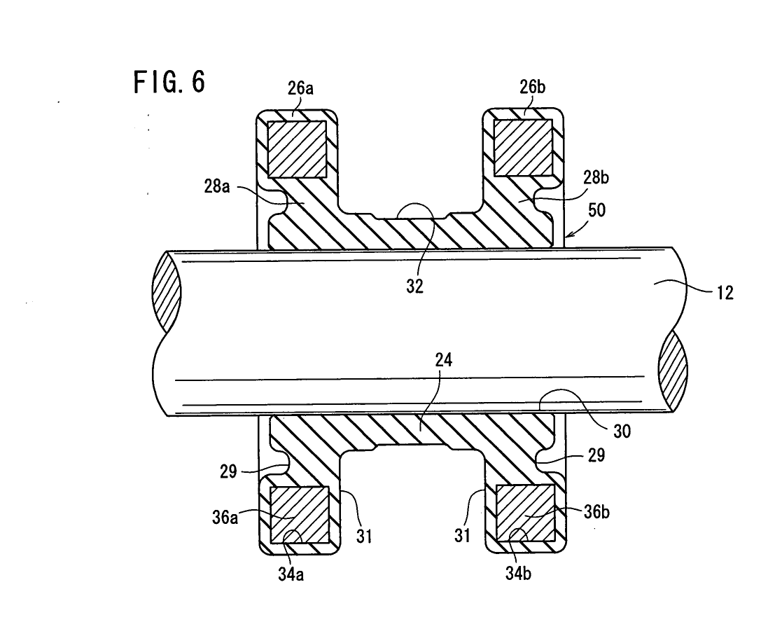

In the above embodiment, the two mass members 26a, 26b are disposed closely to each other (see FIGS. 2 and 3). However, the mass members 26a, 26b are not limited to those positions. As shown in FIG. 6, a dynamic damper 50 may have mass members 26a, 26b disposed at both ends of the main body 24. In this case, the annular recess 32 for winding and tightening the non-illustrate band therein may be disposed centrally in the main body 24.

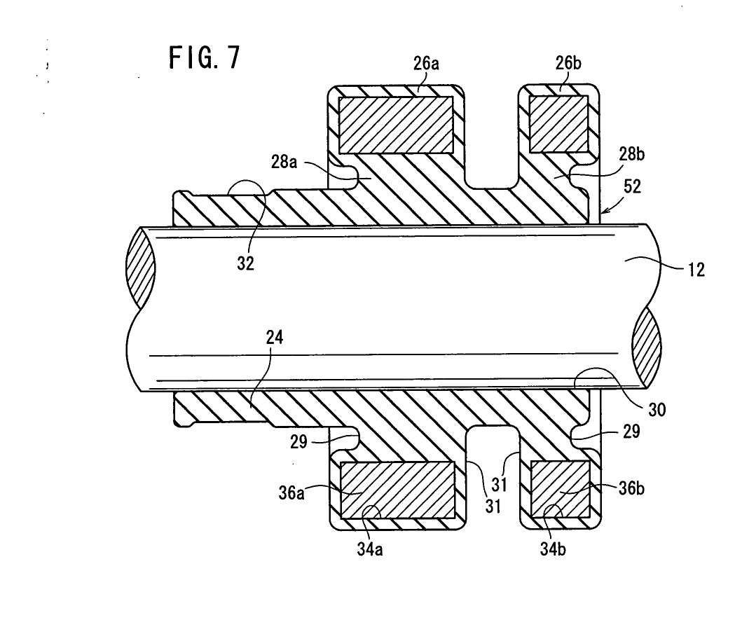

In the embodiment shown in FIG. 6, the mass members 26a, 26b, the weights 36a, 36b, and the joint supports 28a, 28b are essentially identical in shape, and the joint supports 28a, 28b and the joint supports 28a, 28b provide substantially the same resonant frequency. However, the dynamic damper may not be limited to such a configuration. As shown in FIG. 7, a dynamic damper 52 may have mass members 26a, 26b, weights 36a, 36b, and joint supports 28a, 28b which are different in shape to set joint supports 28a, 28b to a different spring constant for a wider range of resonant frequencies that can be set.

A dynamic damper may be constructed by joining the main body 24 and the mass members 26a, 26b and dispensing with the joint supports 28a, 28b. Alternatively, the joint supports 28a, 28b may be included in the mass members 26a, 26b.

The weights 36a, 36b may have different specific gravities and identical dimensions. The specific gravities may be adjusted by varying the type and amount of a polymeric binder or a metal binder.

A tungsten powder, instead of a tungsten alloy powder, may be used, and a molded body fabricated by a sintering, an MIM process, or a PIM process may be used.

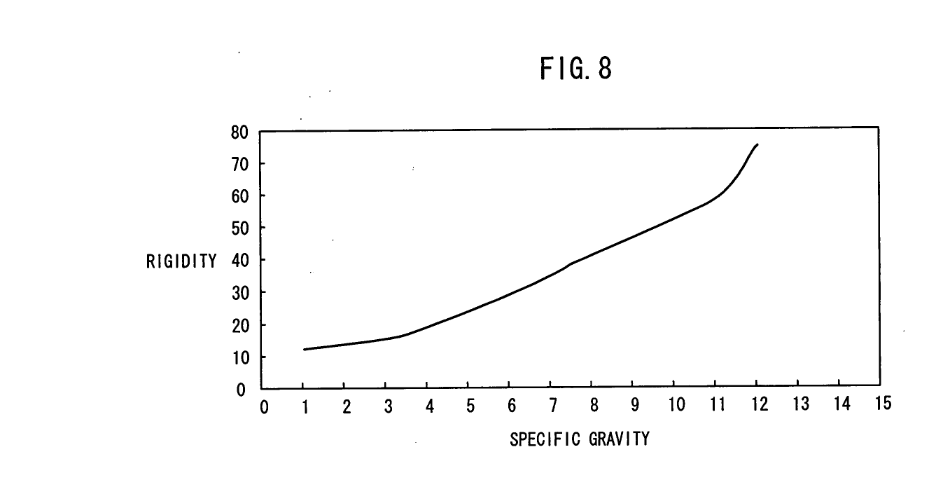

A polymeric binder may be used instead of a metal binder. If a resin binder is used, weights having a specific gravity ranging from about 7 to about 16 are produced. If a rubber binder is used, weights having a specific gravity of about 13 are produced. The relationship between the specific gravity and rigidity of the weight 36a, plotted when the proportions of the polymeric binder and the tungsten alloy are varied to vary the specific gravity of the weight 36a is illustrated in FIG. 8. As can be understood from FIG. 8, the rigidity increases as the specific gravity increases.

If a polymeric binder is used, then the specific gravity should preferably range from 9 to 14. The reasons for the specific gravity range are as follows:

For manufacturing the dynamic damper 22, the weight 36a is placed in advance in the cavity 66 of the mold 64 which is constructed of the lower mold 60, the upper mold 62, and the left and right molds 63a, 63b shown in FIG. 5, and a rubber material is injected from the supply passages 68a through 68d defined in the upper mold 62. In this case, the weight 36a is pressed by the rubber material flowing in the cavity 66. Stated otherwise, a pressing force is applied to the weight 36a.

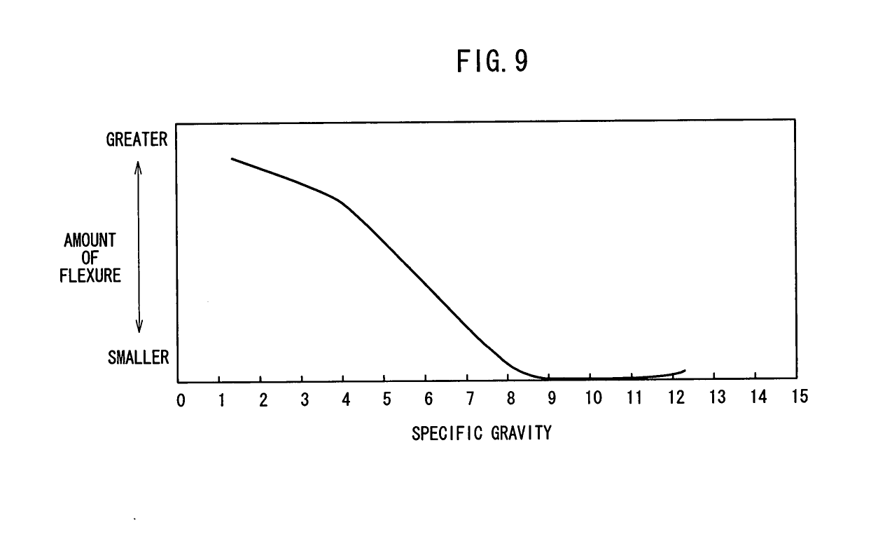

The relationship between the amount of flexure of the weight 36a which is caused by the pressing force and the specific gravity thereof is illustrated in FIG. 9. It can be seen from FIG. 9 that no flexure occurs on the weight 36a when the specific gravity is 9 or more.

If the specific gravity exceeds 14, then the relative amount of the polymeric binder is reduced. Therefore, the tungsten alloy powder or the tungsten powder may not sufficiently be bonded, possibly resulting in a reduction in the strength of the weight 36a.

Preferred examples of the resin binder include nylon resin, polystyrene-based thermoplastic elastomer resin, etc. The weight 36a of this type may be fabricated by an injection molding process or a pressing process.

In the above embodiments, the dynamic dampers 22, 50, 52 with the two mass members 26a, 26b have been described. However, the present invention is not limited to those dynamic dampers. A dynamic damper may have a plurality of, i.e., two or more, mass members.

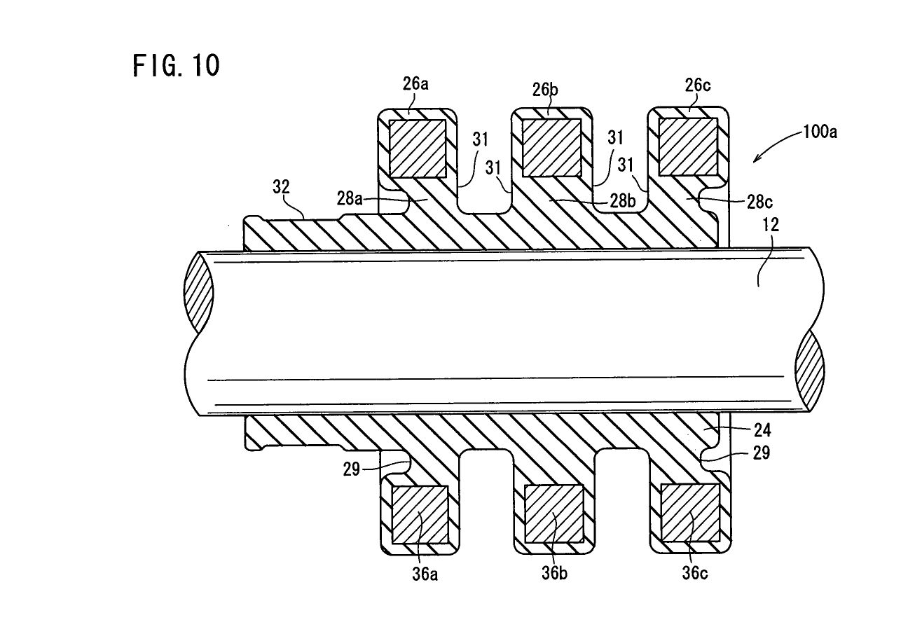

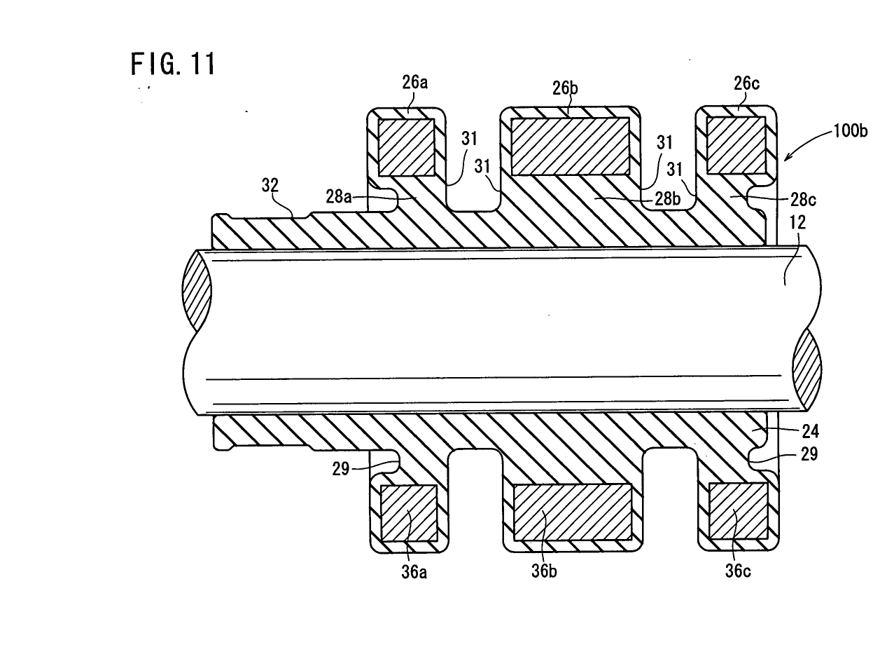

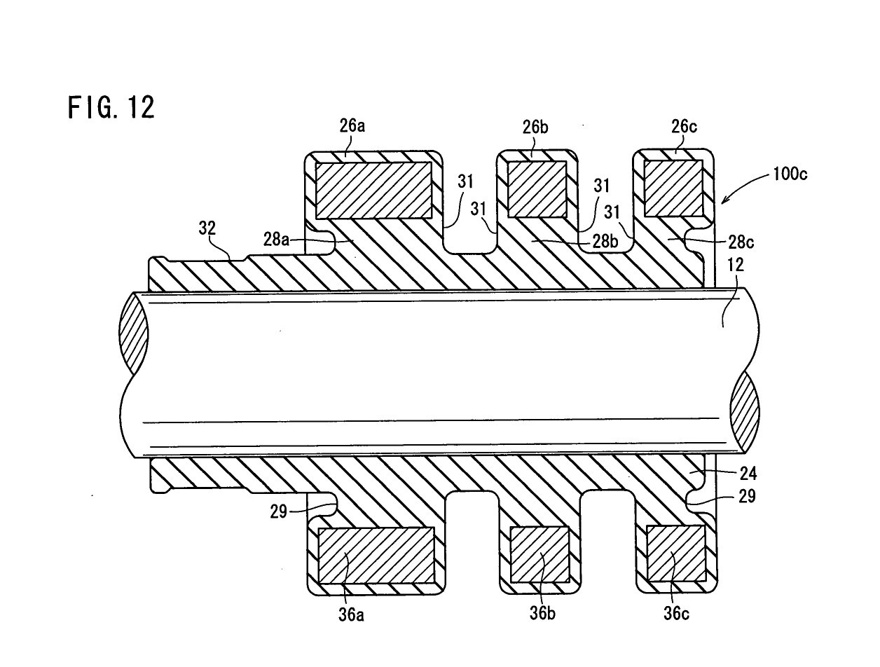

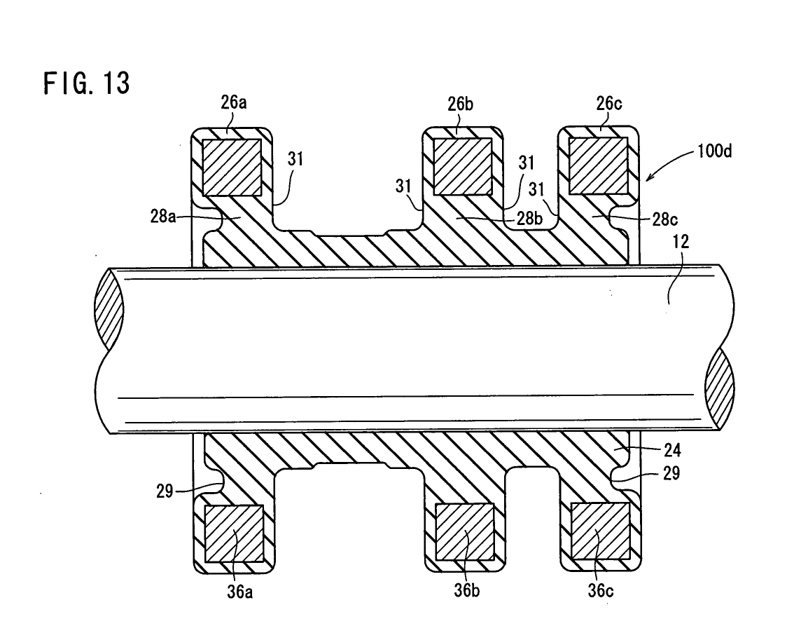

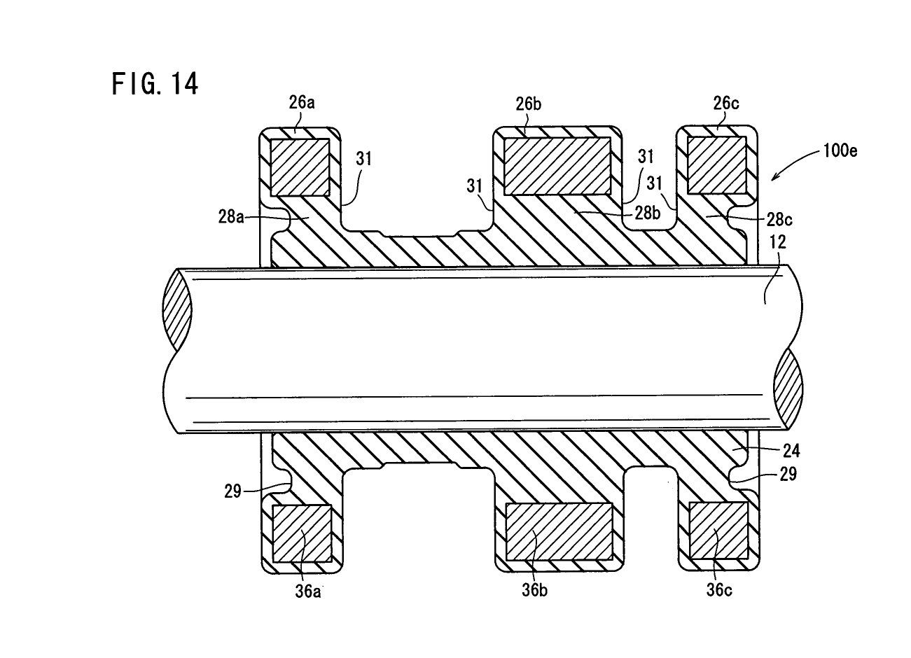

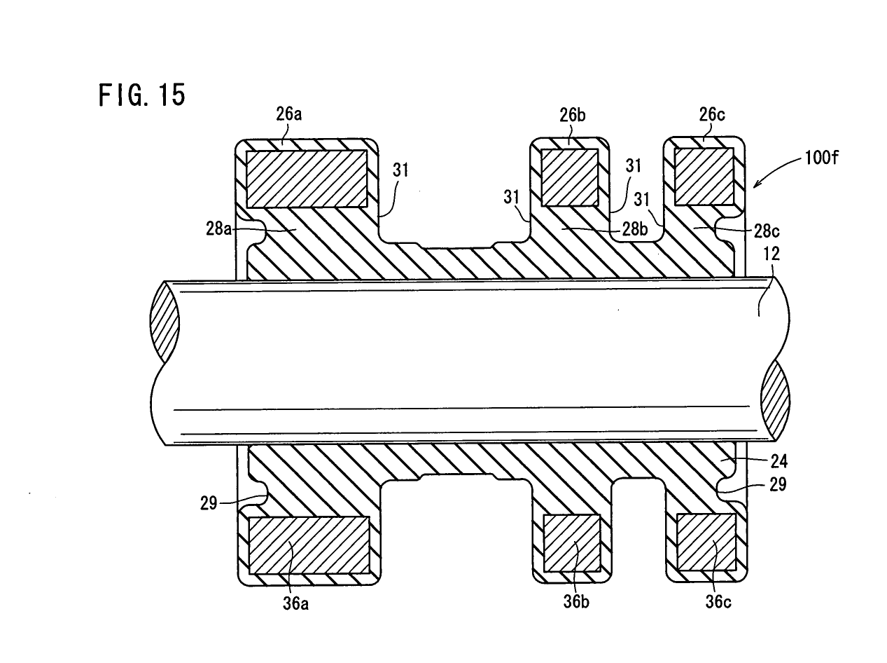

For example, dynamic dampers 100a through 100f having three mass members 26a through 26c (weights 36a through 36c) and joint supports 28a through 28c according to other embodiments are shown in FIGS. 10 through 15.

In the dynamic dampers 100a through 100f according to the other embodiments, parallel flat surfaces 31 which are held in mutually facing relation are provided between the left mass member 26a and the central mass member 26b and between the central mass member 26b and the right mass member 26c which are disposed along the axial direction of the drive shaft 12. The flat surfaces 31 allow the mold from being opened easily.

Other structural and operational details are the same as those of the dynamic dampers 22, 50, 52 with the two mass members 26a, 26b, and will not be described in detail below.

1. A dynamic damper for dampening vibrations of a rotational shaft, comprising:
a main body having a through hole for insertion of said rotational shaft therethrough;
two or more mass members projecting from said main body diametrically outwardly of said rotational shaft and accommodating weights respectively therein; and
flexible annular joint supports disposed between said main body and said mass members;
wherein adjacent ones of said mass members have wall surfaces as flat surfaces extending substantially perpendicularly to an axis of said rotational shaft and confronting each other.

2. A dynamic damper according to claim 1, wherein said weights comprise molded bodies at least containing tungsten or tungsten alloy and a binder.

3. A dynamic damper according to claim 2, wherein said weights have a specific gravity of 9 or more.

4. A dynamic damper according to claim 3, wherein said binder comprises a metal binder, and the specific gravity of said weights is greater than 14.

5. A dynamic damper according to claim 3, wherein said binder comprises a polymeric binder, and the specific gravity of said weights is 14 or smaller.

6. A dynamic damper for dampening vibrations of a rotational shaft, comprising:
a main body having a through hole for insertion of said rotational shaft therethrough;
two or more mass members projecting from said main body diametrically outwardly of said rotational shaft and accommodating weights respectively therein; and
flexible annular joint supports disposed between said main body and said mass members;
wherein if a spaced distance along an axis of said rotational shaft between a central point C of each of said joint supports which bisects a width of each of said joint supports parallel to the axis of said rotational shaft and the center G of gravity of each of said weights is represented by A, and a width of each of said mass members including said weights parallel to the axis of said rotational shaft is represented by B, then said spaced distance A and said width B satisfy a relationship: A≦(B/3).

7. A dynamic damper according to claim 6, wherein said weights comprise molded bodies at least containing tungsten or tungsten alloy and a binder.

8. A dynamic damper according to claim 7, wherein said weights have a specific gravity of 9 or more.

9. A dynamic damper according to claim 8, wherein said binder comprises a metal binder, and the specific gravity of said weights is greater than 14.

10. A dynamic damper according to claim 8, wherein said binder comprises a polymeric binder, and the specific gravity of said weights is 14 or smaller.

11. A dynamic damper for dampening vibrations of a rotational shaft, comprising:
a main body having a through hole for insertion of said rotational shaft therethrough;
two or more mass members projecting from said main body diametrically outwardly of said rotational shaft and accommodating weights respectively therein; and
flexible annular joint supports disposed between said main body and said mass members;
wherein adjacent ones of said mass members have wall surfaces as flat surfaces extending substantially perpendicularly to an axis of said rotational shaft and confronting each other; and
if a spaced distance along an axis of said rotational shaft between a central point C of each of said joint supports which bisects a width of each of said joint supports parallel to the axis of said rotational shaft and the center G of gravity of each of said weights is represented by A, and a width of each of said mass members including said weights parallel to the axis of said rotational shaft is represented by B, then said spaced distance A and said width B satisfy a relationship: A≦(B/3).

12. A dynamic damper according to claim 11, wherein said weights comprise molded bodies at least containing tungsten or tungsten alloy and a binder.

13. A dynamic damper according to claim 12, wherein said weights have a specific gravity of 9 or more.

14. A dynamic damper according to claim 13, wherein said binder comprises a metal binder, and the specific gravity of said weights is greater than 14.

15. A dynamic damper according to claim 13, wherein said binder comprises a polymeric binder, and the specific gravity of said weights is 14 or smaller.
